(19) United States
(12) Patent Application Publication
(10) Pub. No.: US 2026/0084895 A1
(43) Pub. Date: Mar. 26, 2026

(54) Bag Dispenser

(71) Applicant: Orval Windham, APO AE, TX (US)

(72) Inventor: Orval Windham, APO AE, TX (US)

(21) Appl. No.: 18/894,195

(22) Filed: Sep. 24, 2024

(51) Int. Cl. B65F 1/06; B65F 1/14

(52) U.S. Cl. CPC B65F 1/062; B65F 1/1473

(57) ABSTRACT

A bag dispenser apparatus for dispensing bags stored in a rolled configuration includes a housing with an interior surface that defines a volume therein. The interior surface has a cylindrical shape, and the volume is sized and configured to accommodate a roll of bags. The housing defines a first opening at a first end of the housing through which the roll of bags may be inserted into the volume. The housing defines a dispensing slot which extends through a top side of the housing into the volume and is elongated in a direction from the first end of the housing to a second end thereof.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to bag dispensers and more particularly pertains to a new bag dispenser for dispensing bags stored in a rolled configuration.

### (2) Description of Related Art including information disclosed under 37 CFR 1.97 and 1.98.

The prior art discloses myriad bag dispensers, including those which are mounted to a garbage receptacle and those which dispense bags from a rolled configuration. However, the prior art fails to describe such an apparatus which has opposing openings in a tubular housing for receiving a roll of bags and which maintains the bags in the tubular housing via engagement between the bags and a slot in the housing.

### BRIEF SUMMARY OF THE INVENTION

An embodiment of the disclosure meets the needs presented above by generally comprising a housing with an interior surface that defines a volume therein. The interior surface has a cylindrical shape, and the volume is sized and configured to accommodate a roll of bags. The housing defines a first opening at a first end of the housing through which the roll of bags may be inserted into the volume. The housing defines a dispensing slot which extends through a top side of the housing into the volume and is elongated in a direction from the first end of the housing to a second end thereof.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a bag dispenser apparatus according to an embodiment of the disclosure storing a roll of bags.

FIG. 2 is an exploded view of an embodiment of the disclosure and a roll of bags.

FIG. 3 is a top view of an embodiment of the disclosure.

FIG. 4 is a bottom view of an embodiment of the disclosure.

FIG. 5 is a cross-section view of an embodiment of the disclosure taken from lines 5-5 in FIG. 1.

FIG. 6 is an in-use view of an embodiment of the disclosure.

FIG. 7 is a perspective view of an embodiment of the disclosure.

### DETAILED DESCRIPTION OF THE INVENTION

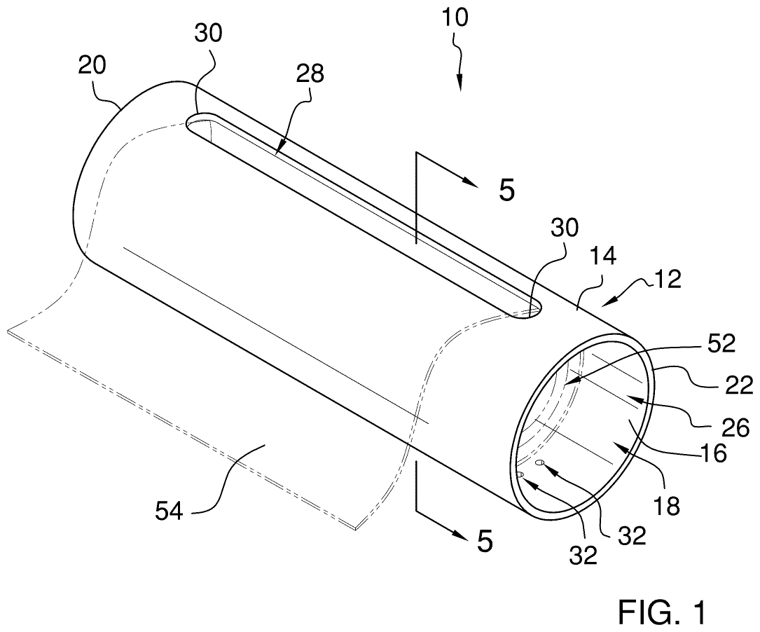

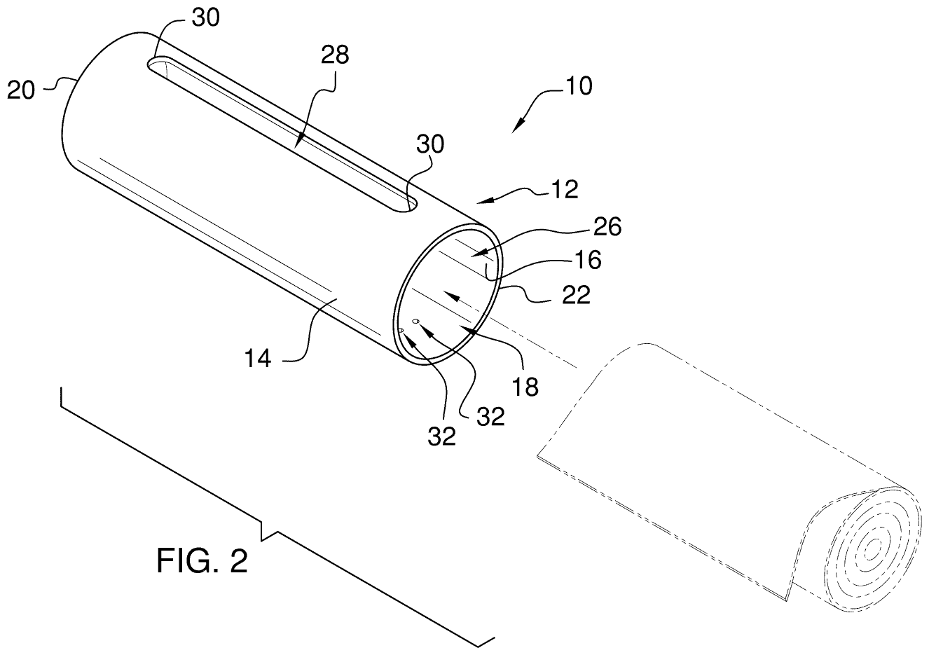

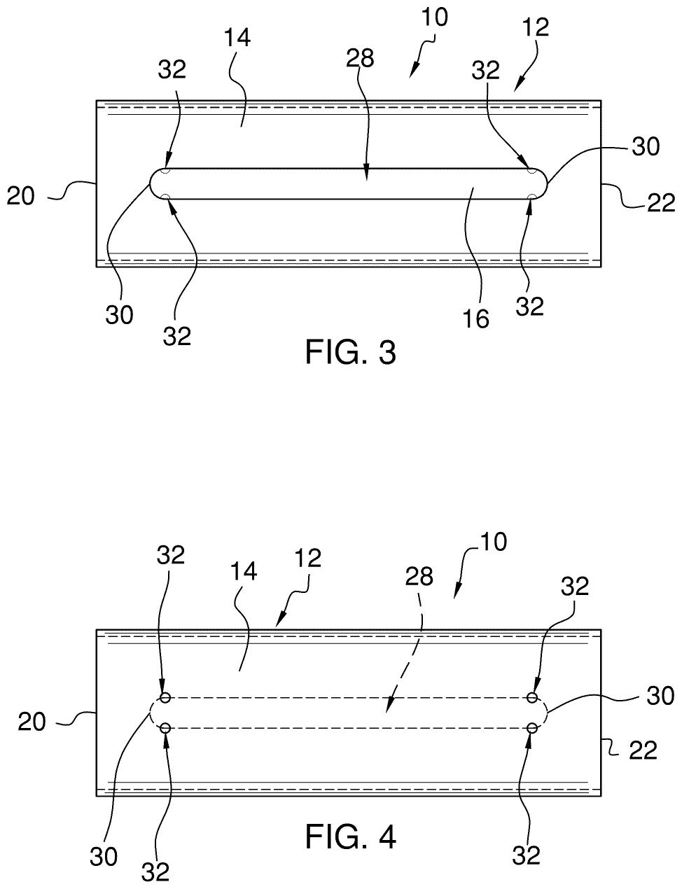

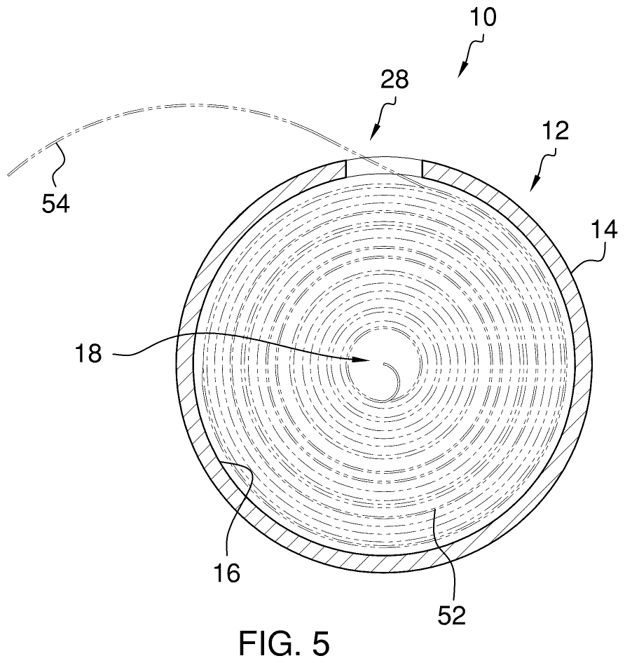

With reference now to the drawings, and in particular to FIGS. 1 through 7 thereof, a new bag dispenser embodying the principles and concepts of an embodiment of the disclosure and generally designated by the reference numeral 10 will be described.

As best illustrated in FIGS. 1 through 7, the bag dispenser apparatus 10 generally comprises a housing 12 with a cylindrical tube shape defining a volume 18 therein bounded by an interior surface 16. The volume 18 is sized to accommodate a roll of bags 52, typically of the variety that is constructed of bags that are interleaved with each other or coupled end-to-end with each other such that they may be removed one at a time. Perforations may be used for rolls of bags that are coupled end-to-end to aid in tearing bags apart from each other during dispensing. A first opening 24 is defined at a first end 20 of the housing 12, and a second opening 26 is defined at a second end 22 of the housing 12 opposite the first end 20. During use, the roll of bags 52 may be inserted into the housing 12 through either of the first opening 24 or the second opening 26. In some cases, the roll 52 may start with a width that is complementary in width to the volume 18 of the housing 12.

The housing 12 defines a dispensing slot 28 which extends through a top side of the housing 12 into the volume 18. The dispensing slot 28 is elongated in a direction from the first end 20 of the housing 12 to the second end 22. The dispensing slot 28 has a length complementary in size to a width of the roll of bags 52. The dispensing slot 28 has a pair of rounded ends 30.

The housing 12 defines a plurality of mounting holes 32 which extend through the housing 12 to the volume 18. Fasteners may be received through the mounting holes 32 to mount the housing 12 to a support member, such as a garbage collection bin, a wall, a platform, or any other suitable support structure. The fasteners may be threaded fasteners which extend into the support member to secure the housing 12 to the support member. The fasteners also may be ties, such as zip ties, wire ties, string, or the like, which threads through the mounting holes 32 and wraps around a suitable portion of the support member to tie the housing 12 to the support member. The mounting holes 32 are positioned on a bottom side of the housing 12 opposite the dispensing slot 28.

In use, the bag dispenser apparatus 10 holds the roll of bags 52 after the roll 52 has been inserted into one of the first opening 24 and the second opening 26 of the housing 12. A leading end 54 of the roll of bags 52 is drawn through the dispensing slot 28 out of the volume 18 of the housing 12. The leading end 54 may be pulled to draw out an endmost bag of the roll 52, allowing the endmost bag to be removed from the roll 52 at defining a new endmost bag at a new leading end 54 of the roll 52. The dispensing slot 28 helps maintain the roll of bags 52 in the housing 12 by engaging the leading end 54 of the roll 52 in the event the roll 52 shifts along the length of the dispensing slot 28. The dispensing slot 28 thereby prevents the roll 52 from sliding out one of the first opening 24 and the second opening 26. The rounded ends 30 of the dispensing slot 28 help the dispensing slot 28 to avoid bunching the bags of the roll 52. As the endmost bag slides against one of the rounded ends 30, it is guided along the contour of the rounded end 30 rather than abutting a perpendicular or otherwise abruptly angled surface of the dispensing slot 28. By sliding along the contour of the rounded end 30, friction builds against the bag's movement rather than allowing the bag continue to bunch up.

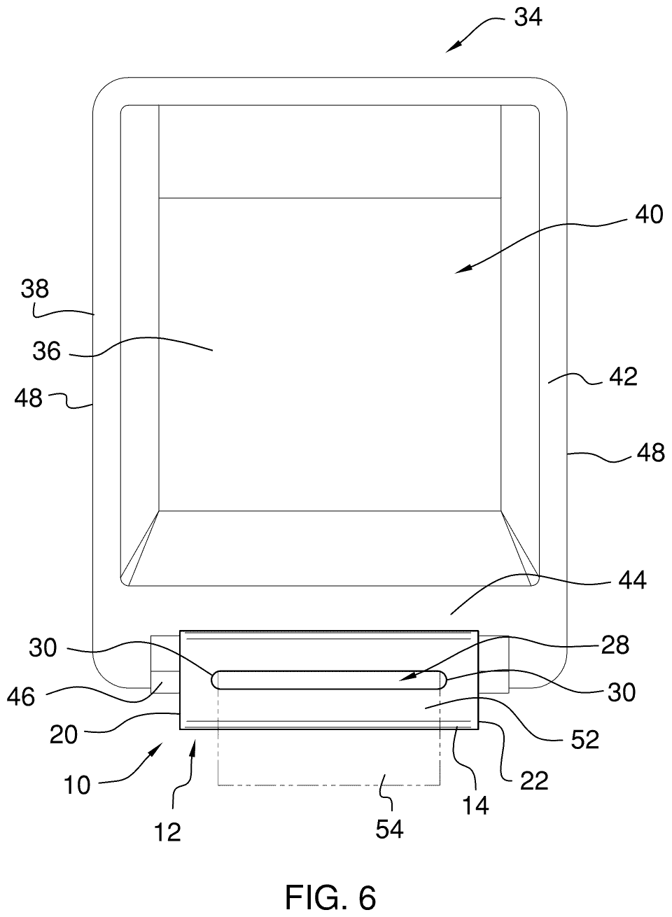

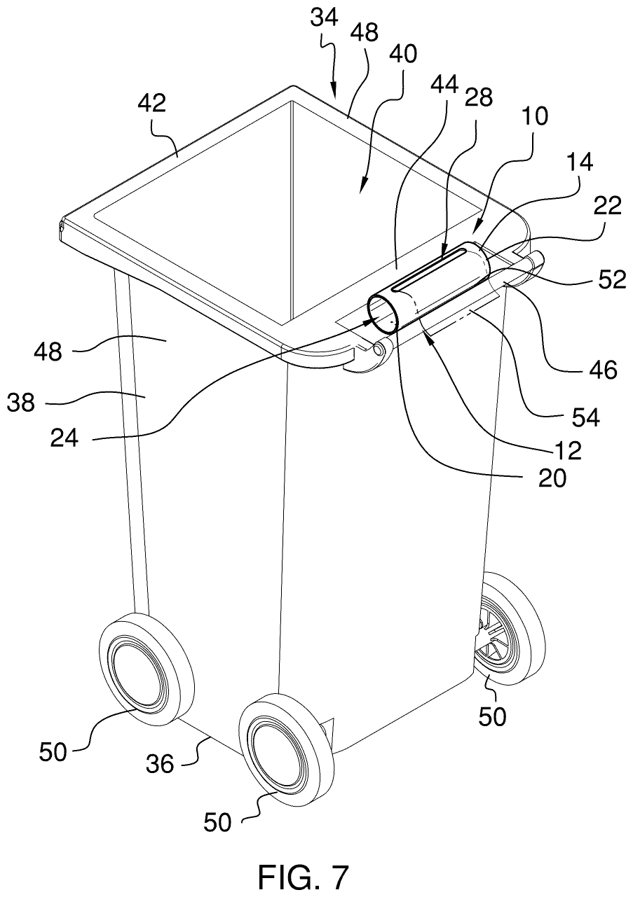

With reference to FIGS. 6 and 7, the bag dispenser apparatus 10 may be used in an assembly with a collection bin 34 for collecting garbage or other articles. The resulting assembly provides a location to store articles in bags drawn from the bag dispenser apparatus 10 and situates the bag dispenser apparatus 10 in an advantageous position for the user. The collection bin 34 has a bottom wall 36 and a perimeter wall 38. The perimeter wall 38 is coupled to and extends away from the bottom wall 36, thereby defining a cavity 40 in the collection bin 34 surrounded by the bottom wall 36 and the perimeter wall 38. The cavity 40 is open at a top end of the collection bin 34.

The collection bin 34 also has a handle 46 mounted at a side portion 44 of a rim 42 of the perimeter wall 38. The handle 46 is spaced from and extends substantially parallel to the side portion 44 of the rim 42. The bag dispenser apparatus 10 lies along the handle 46, extending from its first end 20 to its second end 22 in a direction extending between a pair of lateral sides 48 of the perimeter wall 38. The bag dispenser apparatus 10 may be mounted to the handle 46 or to the rim 42 via suitable fasteners. The exterior surface 14 of the housing 12 has a cylindrical shape to facilitate gripping and using as a substitute handle. In other embodiments, the exterior surface 14 of the housing 12 may have other shapes suitable for gripping, such as including recesses for receiving fingers, for example. A length of the housing 12 is less than a width of the collection bin 34 between the lateral sides 48 to facilitate the user to alternately grip the collection bin 34 on either side of the bag dispenser apparatus 10 during use. Wheels 50 are mounted to the bottom wall 36 of the collection bin 34 to facilitate moving the assembly across a floor surface.

In use, the assembly may be moved via gripping the bag dispenser apparatus 10 or gripping the collection bin 34 on either side of the bag dispenser apparatus 10. The user may then remove the endmost bag from the roll 52 as needed, fill the removed bag, and place the filled bag into the cavity 40 of the collection bin 34. In other cases, the user may use the assembly to replace bags on receptacles. In such cases, the user moves the assembly as described, places filled bags from various receptacles into the cavity 40 of the collection bin 34, and replaces the filled bags with new bags from the roll 52 in the bag dispenser apparatus 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bag dispenser apparatus comprising:
a housing, the housing having an interior surface defining a volume therein, the interior surface having a cylindrical shape, the volume being sized and configured to accommodate a roll of bags, the housing defining a first opening at a first end of the housing; and
wherein the housing defines a dispensing slot which extends through a top side of the housing into the volume, the dispensing slot being elongated in a direction from the first end of the housing to a second end thereof.

2. The apparatus of claim 1, wherein the housing defines a second opening at the second end of the housing.

3. The apparatus of claim 1, wherein the housing has an exterior surface which has a cylindrical shape.

4. The apparatus of claim 1, wherein the dispensing slot has a length complementary in size to a width of the roll of bags.

5. The apparatus of claim 1, wherein the dispensing slot has a pair of rounded ends.

6. The apparatus of claim 1, wherein the housing defines a plurality of mounting holes which extend through the housing to the volume, the plurality of mounting holes being configured to receive fasteners therethrough to mount the housing to a support member.

7. The apparatus of claim 6, wherein the plurality of mounting holes is positioned on a bottom side of the housing.

8. A bag dispenser apparatus comprising:
a housing, the housing having an interior surface defining a volume therein, the interior surface having a cylindrical shape, the volume being sized and configured to accommodate a roll of bags, the housing defining a first opening at a first end of the housing, the housing defining a second opening at a second end of the housing, the housing having an exterior surface which has a cylindrical shape;
wherein the housing defines a dispensing slot which extends through a top side of the housing into the volume, the dispensing slot being elongated in a direction from the first end of the housing to the second end, the dispensing slot having a length complementary in size to a width of the roll of bags, the dispensing slot having a pair of rounded ends; and
wherein the housing defines a plurality of mounting holes which extend through the housing to the volume, the plurality of mounting holes being configured to receive fasteners therethrough to mount the housing to a support member, the plurality of mounting holes being positioned on a bottom side of the housing.

9. A garbage collection assembly comprising:
a collection bin having a bottom wall and a perimeter wall, the perimeter wall being coupled to and extending away from the bottom wall, the collection bin defining a cavity surrounded by the bottom wall and the perimeter wall, the cavity being open at a top end thereof; and
a bag dispenser apparatus mounted to the collection bin, the bag dispenser apparatus being positioned at a side portion of a rim of the perimeter wall, the bag dispenser apparatus comprising a housing, the housing having an interior surface defining a volume therein, the interior surface having a cylindrical shape, the volume being sized and configured to accommodate a roll of bags, the housing defining a first opening at a first end of the housing; the housing extending from the first end to a second end thereof in a direction extending between a pair of lateral sides of the collection bin, the housing defining a dispensing slot which extends through a top side of the housing into the volume, the dispensing slot being elongated in a direction from the first end of the housing to the second end.

10. The assembly of claim 9, wherein the collection bin has a handle mounted to the perimeter wall, the handle being spaced from and extending substantially parallel to the side portion of the rim of the perimeter wall.

11. The assembly of claim 9, wherein the collection bin further comprises wheels mounted to the bottom wall.

12. The assembly of claim 9, wherein the housing of the bag dispenser apparatus defines a second opening at the second end of the housing.

13. The assembly of claim 9, wherein a length of the housing is less than a width of the collection bin between the lateral sides.

14. The assembly of claim 9, wherein the housing has an exterior surface which has a cylindrical shape.

15. The assembly of claim 9, wherein the dispensing slot has a length complementary in size to a width of the roll of bags.

16. The assembly of claim 9, wherein the dispensing slot has a pair of rounded ends.

17. The assembly of claim 9, wherein the housing defines a plurality of mounting holes which extend through the housing to the volume, the plurality of mounting holes being configured to receive fasteners therethrough to mount the housing to the garbage collection bin.

18. The assembly of claim 9, wherein the plurality of mounting holes is positioned on a bottom side of the housing.
